(19) United States
(12) Patent Application Publication
(10) Pub. No.: US 2007/0150812 A1
(43) Pub. Date: Jun. 28, 2007

(54) User support system integrating FAQ and helpdesk features

(75) Inventor: Michael Noel Hu, Langley (CA)

Correspondence Address: YING CHEN, 255 S. GRAND AVE., # 215, LOS ANGELES, CA, 90012, US

(73) Assignee: EazyPaper Inc.

(21) Appl. No.: 11/317,773

(22) Filed: Dec. 23, 2005

(51) Int. Cl. G06F 17/00

(52) U.S. Cl. 715/705

(57) ABSTRACT

A user support system and related user interface that integrates FAQ features and helpdesk features. The user interface screen includes menu windows that allow the user to select a main category and a subcategory of the support topic, and displays a list of frequently asked questions (FAQ) based on the user-selected main category and subcategory. A message input window and associated metadata windows are also displayed on the user interface screen, which allow the user to send a question to the support provider. The support provider then communicates with the user through email or other means to provide answers to the user's questions. Optionally, after the support request is resolved, the question and answer may be used to update the FAQ database, taking into consideration the category and subcategory already selected by the user.

### BACKGROUND OF THE INVENTION

1. Field of the Invention

This invention relates to a user support system, and in particular, it relates to a user support system interface with integrated FAQ and helpdesk features.

2. Description of the Related Art

Many websites have a FAQ (frequently asked questions) section to answer the most common customer questions. Many other websites have a helpdesk system where customers can send in their support questions and a technical support team will answer them, and track them by a server-generated ticket number. All the members of the technical support team can answer a given ticket because the entire thread is tracked by the ticket id, and thus the support load can be distributed among the entire technical support team.

### SUMMARY OF THE INVENTION

While many websites have a FAQ section and a helpdesk system, none appear to have an integrated FAQ and helpdesk system. When users look for support on a website, they may find the FAQ section first and browse it. If they cannot find the answer, they either give up, or do further searches for the helpdesk system or support email. This non-integrated approach to an FAQ and helpdesk system can be aggravating to a user. A worse case would be if the user skips the FAQ section or does not find it, and then generates a support request through the helpdesk system which is answered by the FAQ section. This non-integrated approach to an FAQ and helpdesk system generates unnecessary support requests, which increases the cost to the vendor and forces the user to wait for an answer.

The present invention provides an integrated FAQ and helpdesk system. The system reduces support requests by integrating the FAQ and helpdesk system in an easy to use manner.

The present invention is directed to a method of providing user support that substantially obviates one or more of the problems due to limitations and disadvantages of the related art.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides a method of providing user support through a user interface screen, including: displaying on the screen one or more menu windows for selecting one or more levels of support categories by a user; displaying on the screen a list of frequently asked questions based on a user selection of the support categories; and displaying on the screen a message input window for entering questions by the user.

It is to be understood that both the foregoing general description and the following detailed description are exemplary and explanatory and are intended to provide further explanation of the invention as claimed.

### BRIEF DESCRIPTION OF THE DRAWINGS

FIG. 1 illustrates a user interface screen for a user support system according to an embodiment of the present invention.

FIGS. 2a-2b illustrate the control flow for handling a support request according to an embodiment of the present invention.

### DETAILED DESCRIPTION OF THE PREFERRED EMBODIMENTS

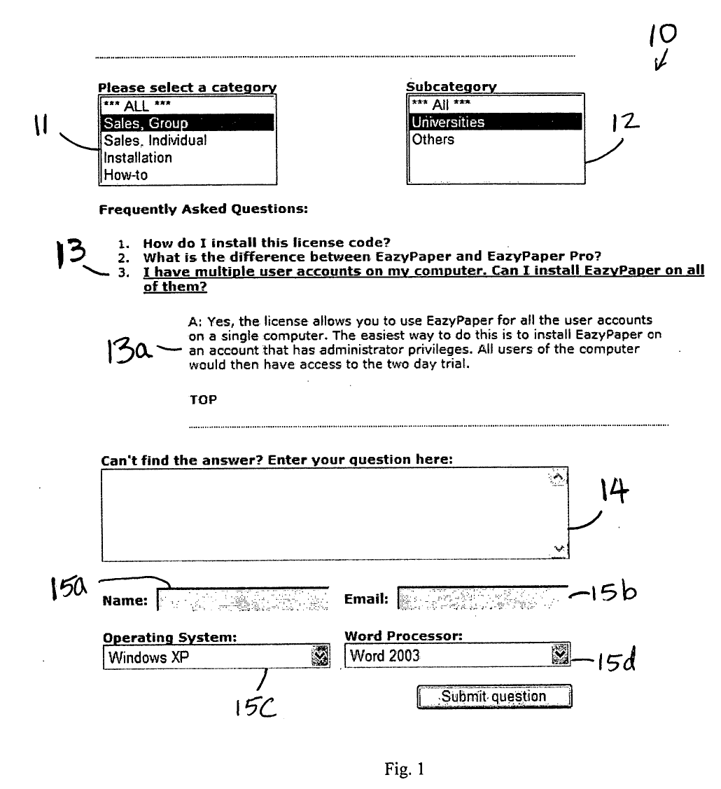

FIG. 1 illustrates a user interface screen (e.g. a webpage displayed on a user's computer) for a user support system according to an embodiment of the present invention. The interface screen may be implemented as a part of a product vender's website to provide user support, which is reached when the user browses to a support page of the vendor. As shown in FIG. 1, the webpage 10 has a first menu window 11 that allows the user to select a main category of the support topic, and a second menu window 12 that allows the user to select a subcategory. The subcategories displayed in the window 12 are automatically generated and updated based on the support category selected by the user. Although two levels of categories (main category and subcategory), more levels of categories may be provided (in additional menu windows) if desired. Once the user selects the category and subcategory, a list of frequently asked questions (FAQ) 13 corresponding to the selected category and subcategory are automatically displayed on the screen. The user may then click on a question of interest, and the answer 13a to the selected question is displayed in response. The display may highlight the selected question to indicate the question being answered, or display the answer in a spatial relationship with the selected question (i.e. immediately below it) to indicate the question being answered. Clicking on the FAQ entry again hides the answer. Alternatively, answers to all questions may be displayed simultaneously on the screen, but this is less preferred as it tends to overcrowd the screen.

On the same screen, a message input window 14 is provided. Upon reviewing the FAQ and answers, if the user cannot find the solution he is looking for, he may submit his question to the vendor using the message input window 14. Additional windows 15a-d are also provided for the user to enter additional metadata about the support request, such as the users name and email address, the operating system and application program the user is using. The items of metadata gathered are specified by the vendor, but at least the email address should be required in order for the vendor to communicate with the user.

Once the user clicks a “submit question” button to submit the question, the user support system generates a support request, and attaches the solicited metadata as well as the category and subcategory of the question to the support request. The system also generates a ticket id for the support request, and routes it to the assigned technical support team member based on the category and subcategory of the request.

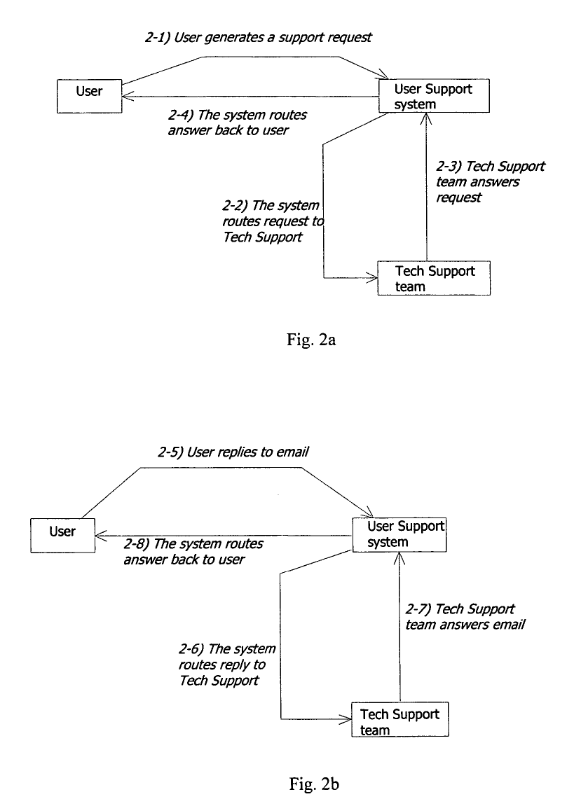

FIGS. 2a-2b illustrate the control flow for handling a support request. The process starts with the user 21 sending a support request to the user support system 22 (Step 2-1) using the interface shown in FIG. 1 and described above. The system 22 routes the support request to a technical support team member 23 (Step 2-2). The technical support team member answers the support request through a support management interface (Step 2-3). The support management interface is a part of the user support system that allows support team member to provide answers to users' questions and perform other support functions. It is a webpage hosted off the same server as the front-end user interface of the user support system, or a separate program that talks to a database of support tickets. The user support system associates the answer with the support request (as identified by the ticket id), and sends an email with the answer to the user and includes the ticket id in the subject line (Step 2-4).

After receiving the email with the answer, the user 21 may reply to the email (Step 2-5). The support system 22 adds the user's reply to the ticket id's ongoing thread (the ticket id is in the subject header) and notifies the technical support team member 23 of the reply (Step 2-6). The technical support team member answers the support request through the support management interface (Step 2-7). The system adds the reply to the ticket id, and sends an email with the answer to the user and includes the ticket id in the subject line (Step 2-8). Steps 2-5 to 2-8 are repeated until the issue is resolved.

As an alternative or in addition to communicating with the user via email as illustrated in FIGS. 2a-2b, a technical support team member may also communicate with the user by telephone. In this case, the user interface will solicit the user's telephone number.

Optionally, the technical support team member adds the answer to the FAQ database through the support management interface. Note that since the user provided the category and subcategory of the question (the new FAQ entry), the technical support team member only has to add the answer, provided that the user-selected categories are appropriate, and optionally add it to other categories and subcategories where the FAQ entry would be relevant.

Thus, the user support system according to embodiments of the present invention integrates traditional FAQ and helpdesk systems into one unified User Interface (UI) (see FIG. 1). The UI presents the FAQ feature before the helpdesk feature (i.e. asking the user to enter a question), and thus reduces unnecessary support requests that are already answered by the FAQ. Furthermore, the user is immediately presented with an interface that allows him to generate a support request that is not yet answered by the present FAQ database. This reduces user aggravation of searching for the way to generate a support request after browsing through the FAQ.

Further, the user support system according to embodiments of the present invention automatically categories support requests by category and subcategory and thus sorts support emails for the technical support team automatically. This sorting also aids in writing future FAQ entries, as the user has already given the question, and categorized it for the technical support team, which then only has to write the answer.

The user support system is preferably a software based support scheme, and is portable across any operating system or hardware. The preferred embodiment of the user support system is through a web interface to display the interface screen on the user's computer, but it may also be implemented as a client-server application.

The user support system described above may be employed to provide technical support for a software or hardware product, or more generally, it may be used by any organization as a part of its website for interacting with its customers or constituents. In this sense, the terms used in the above description such as “user”, “vendor”, “user support”, “user support system”, “technical support team”, etc. should not be taken to limit the applications of the system and method of the present invention. The term “user” should be broadly interpreted to include any user, customer, members of an organization, constituents, or anyone who uses the support system. The term “vendor” should be broadly interpreted to include a product vendor, a contractor of the vendor, any organization that desires to communicate with its members of constituents via its website, etc., and can be generally referred to as the support provider. The term “user support” should be broadly interpreted to include any form of communicating with a user and responding to user inquires. The user questions are not limited to technical questions but may be any questions of interest to the users or the organizations providing the support system. The term “user support system” and “technical support team” should be broadly interpreted to include a system and staff that provides answers to user questions.

It will be apparent to those skilled in the art that various modification and variations can be made in the user support method and system of the present invention without departing from the spirit or scope of the invention. Thus, it is intended that the present invention cover modifications and variations that come within the scope of the appended claims and their equivalents.

What is claimed is:

1. A method of providing user support through a user interface screen, comprising:
(a) displaying on the screen one or more menu windows for selecting one or more levels of support categories by a user;
(b) displaying on the screen a list of frequently asked questions based on a user selection of the support categories; and
(c) displaying on the screen a message input window for entering questions by the user.

2. The method of claim 1, wherein step (a) includes:
(a1) displaying a first and a second menu window containing a plurality of first level support categories and a plurality of second level support categories, respectively; and
(a2) in response to a user selection of a first level support category, updating the displayed plurality of second level support categories.

3. The method of claim 1, further comprising:
(d1) displaying on the screen an answer to at least one of the frequently asked questions; and
(d2) in response to a user selection of another one of the frequently asked questions, displaying on the screen an answer to the selected question.

4. The method of claim 1, further comprising displaying on the screen one or more additional input windows for entering additional data by the user, the additional data including at least the user's electronic mail address.

5. The method of claim 1, further comprising:
(e) routing a support request to a user support staff, the support request including the questions entered by the user and the categories selected by the user;
(f) receiving from the user support staff a reply to the support request; and
(g) communicating the reply to the user.

6. The method of claim 5, wherein in step (e) the support request further includes a ticket id.

7. The method of claim 5, wherein in step (g) the reply is communicated to the user via electronic mail.

8. The method of claim 5, further comprising:
(h) receiving additional questions from the user regarding the support request;
(i) routing the additional questions to a user support staff;
(j) receiving from the user support staff an additional reply to the additional questions; and
(k) communicating the additional reply to the user.

9. The method of claim 5, further comprising:
adding the questions entered by the user and the corresponding reply by the user support staff to a database of frequently asked questions using the categories selected by the user.
